(19) United States
(12) Patent Application Publication
(10) Pub. No.: US 2008/0270407 A1
(43) Pub. Date: Oct. 30, 2008

(54) SYSTEM FOR ENSURING REFERENTIAL INTEGRITY IN HIGHLY CONCURRENT DATABASE ENVIRONMENTS

(75) Inventors: Paramesh S. DESAI, San Jose, CA (US); Julie A. WATTS, Morgan Hill, CA (US); James Z. TENG, San Jose, CA (US)

Correspondence Address: IBM ST-SVL;SAWYER LAW GROUP LLP, 2465 E. Bayshore Road, Suite No. 406, PALO ALTO, CA, 94303, US

(73) Assignee: INTERNATIONAL BUSINESS MACHINES CORPORATION, Armonk, NY (US)

(21) Appl. No.: 12/140,959

(22) Filed: Jun. 17, 2008

Related U.S. Application Data
(63) Continuation of application No. 10/444,569, filed on May 22, 2003.

(51) Int. Cl. G06F 17/30

(52) U.S. Cl. 707/8; 707/E17.007

(57) ABSTRACT

A system for ensuring referential integrity in a concurrent transaction database environment is disclosed. The system determines when an update to a dependent object requires special processing, and if special processing is required, locating and locking parent objects of the dependent object in share mode prior to committing the update to the dependent object.

### CROSS-REFERENCE TO RELATED APPLICATIONS

Under 35 USC §120, this application is a continuation application and claims the benefit of priority to U.S. patent application Ser. No. 10/444,569, filed May 22, 2003, entitled “Method for Ensuring Referential Integrity in Highly Concurrent Database Environments,” which is incorporated herein by reference.

### FIELD OF THE INVENTION

The present invention relates to referential integrity in highly concurrent database environments, and more particularly to a method for ensuring referential integrity during concurrent transactions that update parent and dependent objects in which the relative location of dependent objects may change.

### BACKGROUND OF THE INVENTION

Relational databases allow for defining relationships between two objects and rules for their coexistence. This is referred to as referential integrity. When such a relationship is defined between two objects, one object is the parent object and the other is a dependent object. For example, relational databases make use of primary keys and foreign keys. A primary key uniquely identifies a row in a table, while a foreign key is an attribute of a table that forms a relationship with another table by storing a primary key value of the related table. Here, the primary key is the parent object and the foreign key is the dependent object. The problem of ensuring that the database does not include any invalid foreign key value is a referential integrity problem, while the database constraint that a value of a given foreign key must match the value of the corresponding primary key is known as a referential constraint.

Referential constraints are applied to database transactions that update or delete a parent object. When a parent object is updated, a constraint check is performed to ensure that there are no dependent objects dependent on the parent object being updated. If such a dependent object exists, then the update to the parent object is not allowed. The referential constraint also applies when a dependent object is updated or inserted to make sure the inserted or updated value matches a value in the parent object.

In a highly concurrent environment, it is always possible that multiple transactions are active in the system at any given time. For example, some transactions may be performing updates or deletes of parent objects, which includes checking for the existence of dependent objects. At the same time, some other transactions may be performing updates on these dependent objects.

One problem is that some updates to dependent objects may change the storage location of the updated object or its index entry, and current methods for performing constraint checks fail to take this possibility into account when searching for dependent objects during constraint checks. For example, assume that one transaction is performing an update or delete of a parent object and is in the process of searching for a dependent object in a particular table. Assume further that a second transaction has performed an update of the dependent object in the table that moves the dependent object from a location ahead of the current search location to a location in the table prior to the current search location. In this case, the first transaction's search for the dependent object will fail. And if the first transaction is a delete of parent object, the delete operation will leave behind a dependent object without a parent object, referred to as an orphan object, which violates the referential constraint.

Accordingly, what is needed is an improved method for ensuring referential integrity in a database environment that allows both concurrent transactions to parent objects and transactions to dependent objects that change the relative locations of the dependent objects.

### SUMMARY OF THE INVENTION

The present invention provides a method for ensuring referential integrity in a concurrent transaction database environment. The method includes determining when an update to a dependent object requires special processing, and if special processing is required, locating and locking parent objects of the dependent object in share mode before moving the dependent object.

According to the method disclosed herein, the situation when a dependent object is moved during the constraint search of a transaction that updates a parent is avoided because the transactions for the parent objects must wait until the update transaction to the dependent object is completed. If the update/delete transaction to a parent object starts before the update to the dependent object, the two transactions will deadlock and one of the transactions will be rolled back. In either event, the present invention prevents non-detection of the existence of the dependent object.

### BRIEF DESCRIPTION OF THE DRAWINGS

FIG. 1 is a block diagram of a relational database system environment in which the present invention operates.

FIG. 2 is a flow chart illustrating a process for ensuring referential integrity in a concurrent database environment in accordance with a preferred embodiment of the present invention.

FIG. 3 is a block diagram illustrating an example table in which an update transaction causes a dependent object to be moved.

FIG. 4 is a block diagram illustrating an example of a table having an index on pertinent and non-pertinent parts.

### DETAILED DESCRIPTION

The present invention relates to referential integrity. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

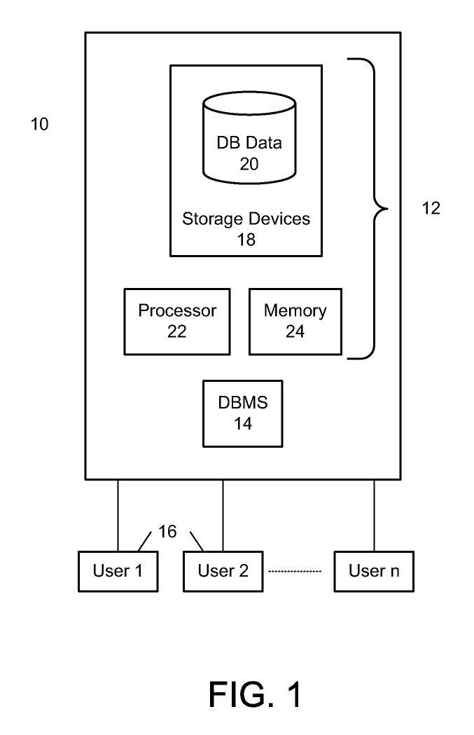

FIG. 1 is a block diagram of a relational database system environment in which the present invention operates. The database system 10 includes database hardware 12, software, such as a database management system (DBMS) 14, and users 16 of the database. The database hardware 12 includes storage devices 18 for storing database data 20, and a processor 22 and memory 24 for executing the DBMS 14. The database data 20 may be located in a central location and/or located remotely via a network, such as the Internet, for example. The database 10 is preferably based on the relational model in which the data 20 is organized as a collection of tables.

Unlike some existing databases, the DBMS 14 in the present environment allows multiple concurrent update transactions, which include update (i.e., modify), delete, and insert operations. Transactions for parent objects that need to perform criteria searches for the existence of dependent objects may perform the searches using different methods, such as table scan searches and index searches. The present invention provides the concurrent database system 10 with a mechanism to ensure that a change in location of a dependent object, or of an index entry for the dependent object, by one transaction does not prevent the detection of the dependent object's existence by another transaction that updates a parent object of the dependent object. The present invention is implemented as one or more software routines that may or may not be part of the DBMS 14.

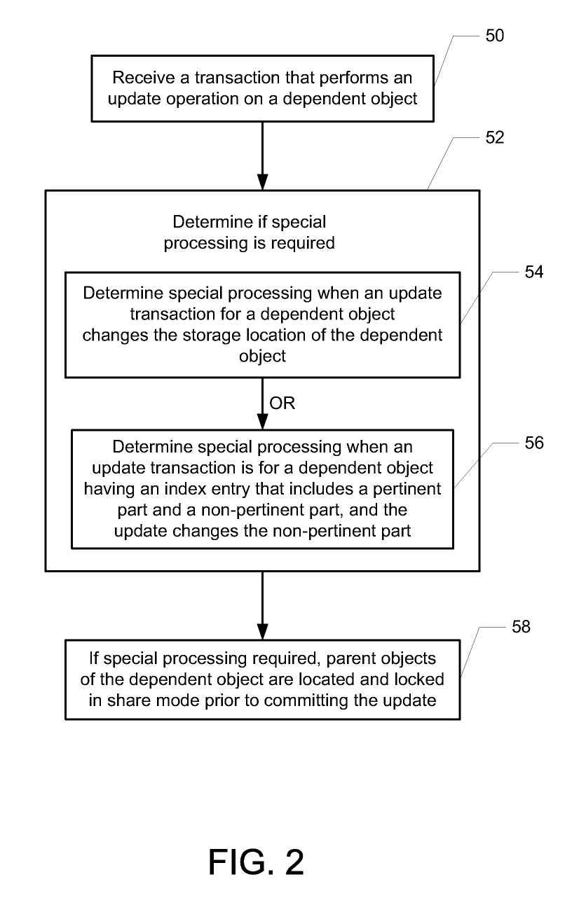

FIG. 2 is a flow chart illustrating a process for ensuring referential integrity in a concurrent database environment in accordance with a preferred embodiment of the present invention. The process begins by receiving a transaction that performs an update operation on a dependent object in step 50. In step 52, it is determined whether the update to the dependent object requires special processing. In a preferred embodiment, the determination of special processing has several steps. In step 54, special processing is determined when an update transaction for a dependent object changes the storage location of the dependent object. This covers the case when an update transaction updates a part of the dependent object that determines which location the object resides in, and the update value is such that it requires moving the dependent object from one location to another.

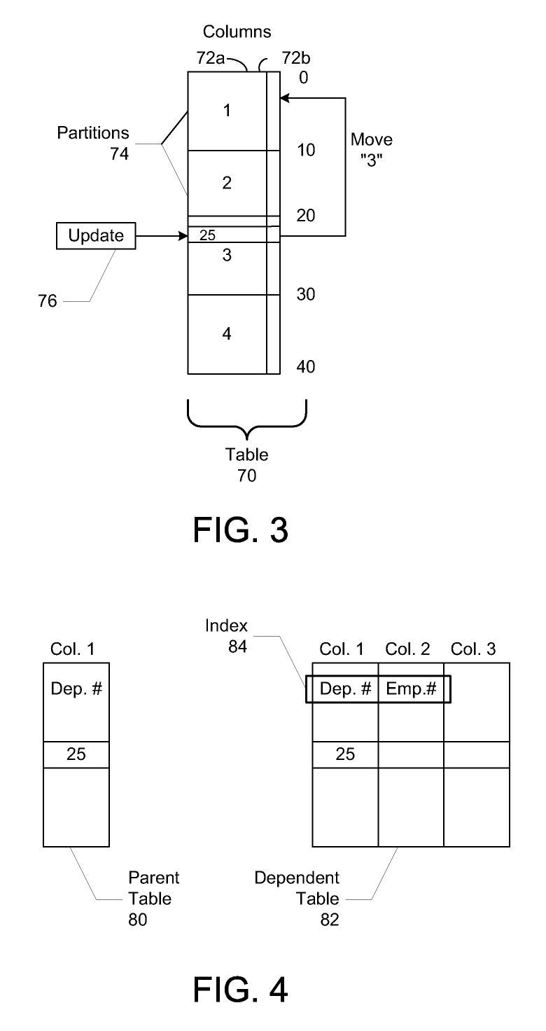

FIG. 3 is a block diagram illustrating an example table in which an update transaction causes a dependent object to be moved. The example table 70 has several columns 72a, 72b, etc., and has four partitions 74. The values in the first column 72a define partition boundaries, such that records having values from 1 to 9 are stored in partition 1, records having values from 10 to 19 are stored in partition 2, records having values from 20 through 29 are stored in partitioned 3, and so on. An update transaction 76 that changes the first column value from “25” to “3” will cause of the updated record to be moved from partition 3 to partition 1.

In this example, the update transaction 76 qualifies for special processing because the first column 72a defines the partition boundaries for the table and therefore controls the location that the record or object resides in the table, and the update transaction 76 changes a value in the first column to one that causes the record to be moved.

Referring again to FIG. 2, in step 56, special processing is also determined when an update transaction is for a dependent object having an index entry that includes a pertinent part and a non-pertinent part, and the update changes the non-pertinent part. As used herein, the pertinent part of the index entry is required to determine the existence of the dependent object, while the non-pertinent part is not required to determine the existence of the dependent object.

FIG. 4 is a block diagram illustrating an example of a table having an index on pertinent and non-pertinent parts. The example shows a parent table 80 having a column containing Department Numbers, which is a primary key. A dependent table 82 is also shown, which has multiple columns, including a Department Number column and an Employee Number column, where the Department Number is a foreign key. An index 84 on the dependent table 82 is defined on both the Department Number and the Employee Number.

If an update transaction for the parent table 82 attempts to change the Department Number value “25”, then a search would be made for a dependent object in the dependent table 82 by performing an index search on the Department Number column having a value of 25. Since the Department Number column in the dependent table is used to determine the existence of the dependent object in this transaction, the Department Number column is the pertinent part of the index.

Now consider an update transaction for the dependent table 82 that attempts to change a value in the Employee number column for a record that has a Department Number value of “25”. In this case, the update would require special processing because Department Number is still the pertinent part of the index because it is used to determine the existence of the record, but the update is to the non-pertinent part of the index because the Employee number column is not used to determine the existence of the dependent object.

Referring again to FIG. 2, in step 54, after it has been determined that the update transaction for the dependent object requires special processing, then prior to moving the dependent object, all parent objects of the dependent object are located and locked in share mode. Because the transaction to the parent objects must wait until the update transaction to the dependent object is complete, the situation when the dependent object is moved during the constraint search performed by the update transaction for the parent object is avoided.

If the update/delete transaction to a parent object starts before the update to the dependent object, the two transactions will deadlock and one of the transactions will be rolled back. In either event, the present invention prevents non-detection of the existence of the dependent object.

The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

What is claimed is:

1. A database system for ensuring referential integrity, the system comprising:
a storage device that stores database data;
database software that allows concurrent transactions to the database data; and
a processor that executes the database software, wherein the database software includes program instructions that when executed by the processor:
determines when an update to a dependent object requires special processing; and
when special processing is required, locates and locks parent objects of the dependent object in share mode prior to moving the dependent object.

2. The system of claim 1 wherein the program instructions further determine that the update requires special processing when an update transaction for a dependent object changes a storage location of the dependent object.

3. The system of claim 2 wherein the program instructions further determine when an update transaction updates a part of the dependent object that determines which location the object resides in, and an update value is such that it requires moving the dependent object from one location to another.

4. The system of claim 3 wherein program instructions further determine that the update requires special processing when the update changes a value in a column that defines partition boundaries for a table, and the value is changed to one that causes the record to be moved.

5. The system of claim 1 wherein program instructions further determine that the update requires special processing when the dependent object has an index that includes a pertinent part and a non-pertinent part, and the update changes the non-pertinent part.

6. The system of claim 5 wherein the pertinent part of the index is required to determine the existence of the dependent object, while the non-pertinent part is not required to determine the existence of the dependent object.

7. A computer-readable medium containing program instructions for ensuring referential integrity in a concurrent transaction database environment, the program instructions which when executed by a computer system cause the computer system to execute a method comprising:
determining when an update to a dependent object requires special processing; and
when special processing is required, locating and locking parent objects of the dependent object in share mode prior to moving the dependent object.

8. The computer-readable medium of claim 7 wherein the program instructions further comprise determining that the update requires special processing when an update transaction for a dependent object changes a storage location of the dependent object.

9. The computer-readable medium of claim 8 wherein program instructions further comprise determining when an update transaction updates a part of the dependent object that determines which location the object resides in, and an update value is such that it requires moving the dependent object from one location to another.

10. The computer-readable medium of claim 9 wherein program instructions further comprises determining that the update requires special processing when the update changes a value in a column that defines partition boundaries for a table, and the value is changed to one that causes the record to be moved.

11. The computer-readable medium of claim 7 wherein program instructions further comprise determining that the update requires special processing when the dependent object has an index that includes a pertinent part and a non-pertinent part, and the update changes the non-pertinent part.

12. The computer-readable medium of claim 11 wherein the pertinent part of the index is required to determine the existence of the dependent object, while the non-pertinent part is not required to determine the existence of the dependent object.
